(19) United States
(12) Patent Application Publication
(10) Pub. No.: US 2025/0282225 A1
(43) Pub. Date: Sep. 11, 2025

(54) VEHICLE CONTROL METHOD AND VEHICLE CONTROL DEVICE

(71) Applicant: Panasonic Automotive Systems Co., Ltd., Kanagawa (JP)

(72) Inventors: Akihito MURAI, Kanagawa Ken (JP); Hirofumi NISHIMURA, Kanagawa Ken (JP)

(73) Assignee: Panasonic Automotive Systems Co., Ltd., Kanagawa (JP)

(21) Appl. No.: 19/075,290

(22) Filed: Mar. 10, 2025

(30) Foreign Application Priority Data
Mar. 11, 2024 (JP) 2024-036615
Feb. 12, 2025 (JP) 2025-020878

(51) Int. Cl. B60K 35/81; B60K 35/28; B60W 30/06; B60W 30/182; B60W 50/14; B60W 60/00; G06V 20/58

(52) U.S. Cl. CPC B60K 35/81; B60K 35/28; B60W 30/06; B60W 30/182; B60W 50/14; B60W 60/005; G06V 20/58; B60K 2360/172; B60K 2360/1868; B60W 2050/146; B60W 2420/403

(57) ABSTRACT

In a vehicle control device 10, in an autonomous driving mode, when an obstacle is detected in front of a vehicle 1 in a moving direction based on an external situation acquired by a sensor 14 while the vehicle 1 is moving from a predetermined position to a parking target position by a first autonomous driving along a teacher route R1, it is switched to a temporary manual driving mode different from a manual driving mode, and an operation device 20 receives a manual operation by an occupant. Then, in the vehicle control device 10, after the vehicle 1 is moved by the manual operation, when the obstacle is not detected in front of the vehicle 1 in the moving direction based on the external situation acquired by the sensor 14, the display device 22 outputs a first screen 30C representing return to the teacher route by the autonomous driving. Then, the vehicle control device 10 performs second autonomous driving to a halfway point between the predetermined position and the parking target position on the teacher route, and thereafter performs third autonomous driving along the teacher route from the halfway point to the parking target position.

### CROSS-REFERENCE TO RELATED APPLICATIONS

This application is based upon and claims the benefit of priority from Japanese Patent Application No. 2024-036615, filed on Mar. 11, 2024 and Japanese Patent Application No. 2025-020878, filed on Feb. 12, 2025; the entire contents of which are incorporated herein by reference.

### BACKGROUND OF THE INVENTION

### 1. Field of the Invention

The present disclosure relates to a vehicle control method and a vehicle control device.

### 2. Description of the Related Art

In general, many houses have narrow parking spaces, making parking difficult in some cases. Therefore, there is a high demand for autonomous driving to perform parking and vehicle retrieval operations.

A vehicle control device that realizes this type of autonomous driving is known. For example, a technique has been disclosed in which a vehicle is driven from a predetermined position to a parking target position by a manual operation of a driver, a movement route at that time is stored in advance as a teacher route, and after that, the vehicle is autonomously driven along the teacher route in a parking scene (refer to Patent Literature 1).

However, during autonomous driving along the teacher route, there may be an obstacle on the teacher route that was not present during the teacher driving. In the related art, in such a case, autonomous parking by autonomous driving may be difficult. That is, in the related art, it may be difficult to provide suitable parking assistance.

The present disclosure has an object to provide a vehicle control method and a vehicle control device capable of providing more suitable parking assistance.

### SUMMARY OF THE INVENTION

A vehicle control method according to the present disclosure is executed by a vehicle that includes a sensor that acquires an external situation, an operation device that receives an operation by an occupant, a steering device that receives a steering operation by the occupant, a display device that is visually recognizable by the occupant, and a movement controller that controls at least steering, the vehicle holding a teacher route obtained by teacher driving from a predetermined position to a parking target position. In the vehicle control method according to the present disclosure, in a manual driving mode, the vehicle is driven in response to a steering operation on the steering device by the occupant, and when the vehicle is within a predetermined range from the predetermined position, and the operation device receives a first operation, switching to an autonomous driving mode is performed, thereafter, in the autonomous driving mode, when an obstacle is detected in front of the vehicle in a moving direction based on an external situation acquired by the sensor during movement from the predetermined position to the parking target position along the teacher route by first autonomous driving controlling at least the steering, switching to a temporary manual driving mode different from the manual driving mode is performed, and the operation device and the steering device receive a manual operation by the occupant, thereafter, in the temporary manual driving mode, after the vehicle is moved by the manual operation, when the obstacle is not detected in front of the vehicle in the moving direction based on the external situation acquired by the sensor, the display device outputs a first screen representing return to the teacher route by autonomous driving, after second autonomous driving is performed to a halfway point between the predetermined position and the parking target position on the teacher route, third autonomous driving is performed along the teacher route from the halfway point to the parking target position, in the manual driving mode, the vehicle is driven in response to a steering operation on the steering device by the occupant, and when the vehicle is within a predetermined range from the predetermined position and the operation device does not receive a first operation, ongoingly in the manual driving mode, the vehicle is driven to the parking target position in response to a steering operation on the steering device by the occupant, and in the temporary manual driving mode, when the operation device receives a second operation, switching to the manual driving mode is performed, and in the manual driving mode, after the vehicle is moved by the manual operation, when the obstacle is not detected in front of the vehicle in the moving direction based on an external situation acquired by the sensor, the display device does not output the first screen indicating return to the teacher route by autonomous driving.

### BRIEF DESCRIPTION OF THE DRAWINGS

FIG. 1 is a block diagram illustrating an example of an overall configuration of a vehicle.

FIG. 2 is a schematic diagram illustrating an example of arrangement of an in-vehicle camera.

FIG. 3 is a schematic diagram illustrating an example of a configuration of an external appearance of the vehicle.

FIG. 4 is a diagram illustrating an example of a configuration in the vicinity of a driver's seat of the vehicle of the present embodiment.

FIG. 5 is an explanatory diagram of an example of a teacher route.

FIG. 6 is an explanatory diagram of an example of estimation processing of a current position of a vehicle executed by a controller during an autonomous driving mode.

FIG. 7 is an explanatory diagram of an example of a case where an obstacle is detected on the teacher route.

FIG. 8A is a schematic diagram of an example of a third screen.

FIG. 8B is a schematic diagram of an example of the third screen.

FIG. 9 is a schematic diagram of an example of a fourth screen.

FIG. 10A is a schematic diagram of an example of a first screen.

FIG. 10B is a schematic diagram of an example of the first screen.

FIG. 11 is an explanatory diagram of an example of generation of a return route.

FIG. 12A is a schematic diagram of an example of a second screen.

FIG. 12B is a schematic diagram of an example of the second screen.

FIG. 13 is a schematic diagram of an example of a fifth screen.

FIG. 14 is a flowchart illustrating an example of a flow of information processing executed by a controller in a teacher driving mode.

FIG. 15 is a flowchart illustrating an example of a flow of information processing executed by the controller in the autonomous driving mode.

FIG. 16 is a flowchart illustrating an example of a flow of interrupt processing executed by the controller.

FIG. 17 is a block diagram illustrating a hardware configuration example of a vehicle control device.

### DESCRIPTION OF EMBODIMENTS

Hereinafter, embodiments of a vehicle control method and a vehicle control device according to the present disclosure will be described with reference to the drawings.

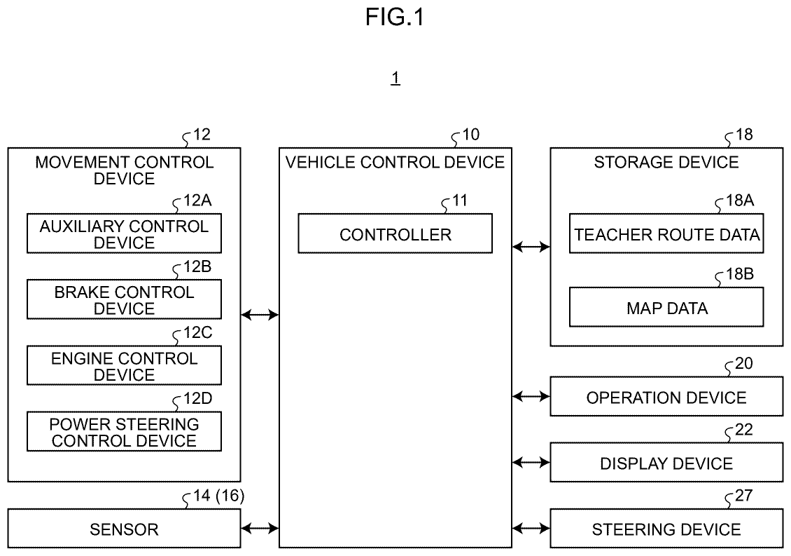

FIG. 1 is a block diagram illustrating an example of an overall configuration of a vehicle 1.

The vehicle 1 includes a vehicle control device 10, a movement control device 12, a sensor 14, a storage device 18, an operation device 20, a display device 22, and a steering device 27.

The movement control device 12, the sensor 14, the storage device 18, the operation device 20, the display device 22, and the steering device 27 are connected to the vehicle control device 10 to be able to exchange data or signals. That is, the vehicle control device 10 is set to be connected to be capable of communicating with at least the sensor 14, the operation device 20, the display device 22, the movement control device 12, and the steering device 27.

The movement control device 12 controls at least steering of the vehicle 1. The movement control device 12 is means for realizing driving, braking, and turning motions necessary for driving of the vehicle 1. For example, the movement control device 12 includes a drive motor, a power transmission mechanism, a brake device, a steering device, and the like, and an electronic vehicle control device that controls the drive motor, the power transmission mechanism, the brake device, the steering device, and the like. The movement control device 12 generates power with the drive motor and transmits the power to wheels via the power transmission mechanism to drive the vehicle 1. The power transmission mechanism is, for example, a propeller shaft, a differential gear, a drive shaft, or the like.

Controlling at least steering means that the movement control device 12 controls at least one of driving, braking, and turning motions necessary for driving of the vehicle 1. That is, controlling steering means that the movement control device 12 controls at least one of a turning direction by steering, a vehicle speed and acceleration by accelerator steering, and deceleration and stop by brake steering. Controlling at least acceleration and deceleration means that the movement control device 12 controls at least one of acceleration and deceleration of the vehicle 1.

Specifically, the movement control device 12 includes an auxiliary control device 12A, a brake control device 12B, an engine control device 12C, and a power steering control device 12D. The brake control device 12B, the engine control device 12C, and the power steering control device 12D can be collectively referred to as an actuator controller that controls the operation of the vehicle 1.

The auxiliary control device 12A is a control device that monitors the transmission state of the vehicle control device 10 and operates to execute appropriate degeneration control as a backup when the vehicle control device 10 fails. Note that even when the vehicle control device 10 fails, when safety can be secured by providing a degeneration control function in the vehicle control device 10, the degeneration control is unnecessary.

The brake control device 12B is a control device that performs brake control of the vehicle 1. The brake control may be referred to as braking force control. For example, the brake control device 12B performs brake control of the vehicle 1 in accordance with enhancement and relaxation of the operation of the brake pedal by the occupant. Specifically, the enhancement of the operation of the brake pedal by the occupant means that the occupant steps on the brake pedal. Furthermore, the brake control device 12B performs brake control according to the surrounding video during autonomous driving.

The engine control device 12C is a control device that controls an engine that generates a driving force of the vehicle 1. The power steering control device 12D is a control device that controls power steering of the vehicle 1.

The sensor 14 is mounted on the vehicle 1 and acquires at least the external situation of the vehicle 1. Specifically, the sensor 14 is various sensors that detect a driving state of the vehicle 1 and the external situation of the vehicle 1. The external situation includes video of the outside of the vehicle 1.

The sensor 14 includes at least a camera 16. Furthermore, the sensor 14 includes at least one of light detection and ranging (LiDAR), radar, sonar, an ultrasonic sensor, and the like. The sensor 14 includes, for example, an accelerator opening sensor that detects an accelerator opening, a steering angle sensor that detects a steering angle of a steering device, an acceleration sensor that detects acceleration acting in the front-rear direction of the vehicle 1, a torque sensor that detects torque acting on a power transmission mechanism between wheels of the vehicle 1 and a drive motor, a vehicle speed sensor that detects a vehicle speed of the vehicle 1, a wheel speed sensor, a global positioning system (GPS), and the like. The sensor 14 outputs sensor information obtained by the detection to the vehicle control device 10.

The camera 16 is a surrounding sensor that is mounted on the vehicle 1 and monitors the surrounding environment of the vehicle 1. In the present embodiment, the camera 16 captures video of the surroundings of the vehicle 1 and outputs captured video data to the vehicle control device 10. Hereinafter, the captured video data may be simply referred to as a video. Furthermore, in the present embodiment, the camera 16 is also applied to an application of detecting an object present around the vehicle 1 and estimating the position where the vehicle 1 is present from the positional relationship between the vehicle 1 and the object present around the vehicle 1.

The position, the number of installations, and the photographing direction of the camera 16 are adjusted in advance such that the periphery of the vehicle 1 can be photographed. For example, the vehicle 1 is provided with four cameras 16 arranged to be able to capture images in four directions of a front direction, a rear direction, a left direction, and a right direction of the vehicle 1. Note that the number of cameras 16 provided in the vehicle 1 is not limited to four.

The storage device 18 stores various data. In the present embodiment, the storage device 18 stores data such as teacher route data 18A and map data 18B. That is, the storage device 18 holds the teacher route represented by the teacher route data 18A. Details of the teacher route data 18A and the map data 18B will be described later.

The storage device 18 is, for example, an auxiliary storage device such as a hard disk drive (HDD), a solid state drive (SSD), or a flash memory. Note that at least a part of the data included in the storage device 18 may be stored in an external storage device such as a server device provided outside the vehicle 1 and connected to be capable of communicating with the vehicle control device 10.

The operation device 20 receives an operation by an occupant of the vehicle 1. The operation device 20 includes an operation mechanism related to a driving operation such as an accelerator pedal, a brake pedal, a blinker lever, and a push-in switch, and an input device such as a keyboard, a touch panel, and a switch.

At least one of the keyboard, the touch panel, and the switch functions as an autonomous parking instruction unit that receives an autonomous parking start instruction.

A shift lever is an example of a forward-backward movement operation unit. The forward-backward movement operation unit switches at least between forward movement and backward movement of the vehicle 1. The brake pedal is an example of a brake operation unit. The brake operation unit is an operation unit for a brake that suppresses the speed of the vehicle 1. That is, the brake operation unit receives an instruction to decelerate the vehicle 1. The operation device 20 may constitute a part of a human machine interface (HMI) or an in-vehicle infotainment (IVI).

The display device 22 is a display that outputs various images. The display device 22 is disposed at a position visually recognizable by the occupant. The display device 22 is installed at a position visually recognizable by the occupant of the vehicle 1. Examples of the display include a liquid crystal display (LCD), an organic electro-luminescence (EL) display, and a projector. The display may be a touch panel display in which the display device 22 and the operation device 20 are integrally configured. The display device 22 is an example of at least one of the HMI and the IVI.

Note that the display device 22 is not limited to one including only one display area. For example, the display device 22 may include a plurality of display areas.

In addition, the vehicle 1 may include a plurality of display devices 22. For example, the display device 22 may include a first display unit and a second display unit, and the first display unit and the second display unit are displays that output various images. The first display unit and the second display unit are display devices 22 configured as separate bodies. The first display unit and the second display unit may be disposed at different positions in the vehicle 1. For example, the first display unit may function as the IVI, and the second display unit may function as a part of the instrument panel of the vehicle 1.

The steering device 27 receives steering by the occupant of the vehicle 1. The steering device 27 is, for example, a steering wheel. The steering wheel may be referred to as a handle. The steering angle of the steering device is adjusted by the operation of the steering device by the occupant.

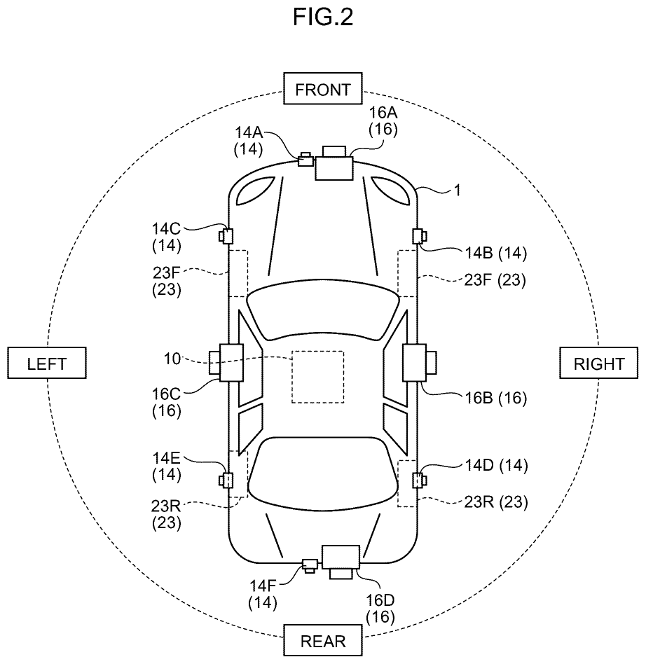

FIG. 2 is an explanatory diagram illustrating an example of arrangement of the sensor 14 and the camera 16.

The vehicle 1 is provided with, for example, four cameras 16 (cameras 16A to 16D) to be able to acquire an external situation of the vehicle 1, for example, in at least four directions: the front, rear, right, and left directions.

Specifically, for example, the camera 16 includes a camera 16A, a camera 16B, a camera 16C, and a camera 16D. The camera 16A is disposed in a front portion of the vehicle 1 and captures an image of the front of the vehicle 1. The camera 16A may be referred to as a front camera. The camera 16B is disposed on the right side of the vehicle 1 and captures an image of the right side of the vehicle 1. The camera 16C is disposed on the left side of the vehicle 1 and captures an image of the left side of the vehicle 1. The camera 16D is disposed in a rear portion of the vehicle 1 and captures an image of the rear of the vehicle 1. The camera 16D may be referred to as a rear camera, a rear portion camera, or the like.

Note that the number of cameras 16 provided in the vehicle 1 is not limited to four. In addition, regarding sensors that detect objects such as a lidar, a radar, a sonar, and an ultrasonic sensor included in the sensor 14, it is preferable that the arrangement positions, the number of arrangements, and the like are adjusted in advance such that the external situations of the right, left, front, and rear sides of the vehicle 1 can be acquired. For example, as illustrated in FIG. 2, the sensor 14 includes sensors 14A to 14F. These sensors 14A to 14F are disposed in the vehicle 1 to be able to acquire external situations of the right, left, front, and rear sides of the vehicle 1. Note that the sensor 14 that detects an object, such as a lidar, a radar, a sonar, or an ultrasonic sensor, may be disposed only in the rear portion of the vehicle 1.

Next, a configuration of the vehicle 1 will be described.

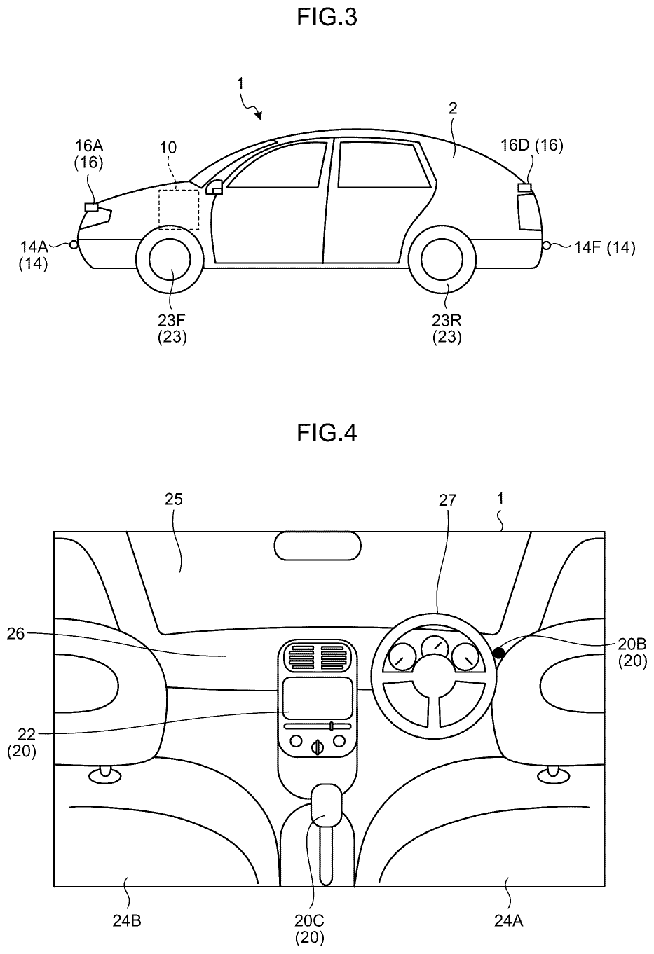

FIG. 3 is a schematic diagram illustrating an example of a configuration of an external appearance of the vehicle 1.

The vehicle 1 includes a vehicle body 2 and two pairs of wheels 23 arranged along a predetermined direction on the vehicle body 2. The two pairs of wheels 23 include a pair of front tires 23F and a pair of rear tires 23R (refer to also FIG. 2). FIGS. 2 and 3 illustrate an example in which the vehicle 1 includes four wheels 23. However, the number of wheels 23 provided in the vehicle 1 is not limited thereto.

Next, a configuration in the vicinity of the driver's seat of the vehicle 1 of the present embodiment will be described.

FIG. 4 is a diagram illustrating an example of a configuration in the vicinity of a driver's seat 24A of the vehicle 1 of the present embodiment.

The vehicle 1 includes a driver's seat 24A and a passenger seat 24B. A windshield 25, a dashboard 26, the steering device 27, an operation button 20B, and the display device 22 are provided in front of the driver's seat 24A. A shift lever 20C, which is a lever for shifting the transmission, is provided in the vicinity of the driver's seat 24A.

The steering device 27, the operation button 20B, and the shift lever 20C are examples of the operation device 20.

The steering device 27 is provided in front of the driver's seat 24A and can be operated by an occupant. The steering device 27 receives the steering operation of the occupant as described above. The rotation angle of the steering device 27, that is, the steering angle is electrically or mechanically interlocked with the change in the direction of the front tires 23F, which are steering wheels. The steering wheels may be the rear tires 23R, or both the front tires 23F and the rear tires 23R may be the steering wheels.

The operation button 20B is a button capable of receiving an operation by the occupant. The operation button 20B may include a direction indicator. The position of the operation button 20B is not limited to the example illustrated in FIG. 4, and may be provided in the steering device 27, for example. Although one operation button 20B is illustrated in FIG. 4, a plurality of operation buttons 20B may be provided. When the display device 22 also serves as a touch panel, the display device 22 may be an example of the operation device 20.

Returning to FIG. 1, the description will be continued.

The vehicle control device 10 is an electronic control unit that integrally controls each unit of the vehicle 1.

The vehicle control device 10 controls the movement control device 12 such that the driving state of the vehicle 1 is optimized using the sensor information, the captured video, and the like received from the sensor 14 and the camera 16, respectively. In addition, the vehicle control device 10 controls the movement control device 12 to autonomously drive the vehicle 1.

The vehicle control device 10 includes a controller 11. A part or all of the controller 11 may be a software configuration realized by cooperation of a processor and various programs stored in a memory. In addition, a part or all of the controller 11 may have a hardware configuration realized by a dedicated circuit or the like.

The controller 11 integrally controls each unit of the vehicle 1.

In the present embodiment, the controller 11 is configured to be able to switch the driving mode to a teacher driving mode, an autonomous driving mode, a manual driving mode, or a temporary manual driving mode based on an input operation or the like of the operation device 20 by the occupant. The driving mode executable by the vehicle 1 may include various driving modes other than the teacher driving mode, the autonomous driving mode, the manual driving mode, and the temporary manual driving mode.

The teacher driving mode is a mode for registering a teacher route when the vehicle 1 is driven autonomously. The teacher route is a route obtained by teacher driving from a predetermined position to a parking target position. In the teacher driving mode, the vehicle 1 is controlled to be driven by the manual operation of the occupant. That is, in the teacher driving mode, the controller 11 controls the movement control device 12 to drive the vehicle 1 in response to the manual operation that is a driving operation by the occupant.

The autonomous driving mode is a mode in which the vehicle 1 is driven autonomously. In the present embodiment, the autonomous driving mode means a mode in which the vehicle 1 is driven autonomously along the teacher route. In the autonomous driving mode, the controller 11 controls at least steering to control the movement control device 12 to drive the vehicle 1 along the teacher route. In the autonomous driving mode, the vehicle 1 is autonomously controlled to be driven by the vehicle control device 10 without the manual operation by the occupant.

The manual driving mode is a driving mode in which the vehicle 1 is driven in response to the steering operation on the steering device 27 by the occupant.

The temporary manual driving mode is a driving mode in which manual driving is temporarily executed in the autonomous driving mode. The temporary manual driving mode is a driving mode different from the manual driving mode. Specifically, the temporary manual mode is a driving mode in which the operation device 20 and the steering device 27 temporarily receive the manual operation by the occupant to drive the vehicle 1 during autonomous driving, and then the vehicle 1 is driven autonomously when a predetermined condition is satisfied.

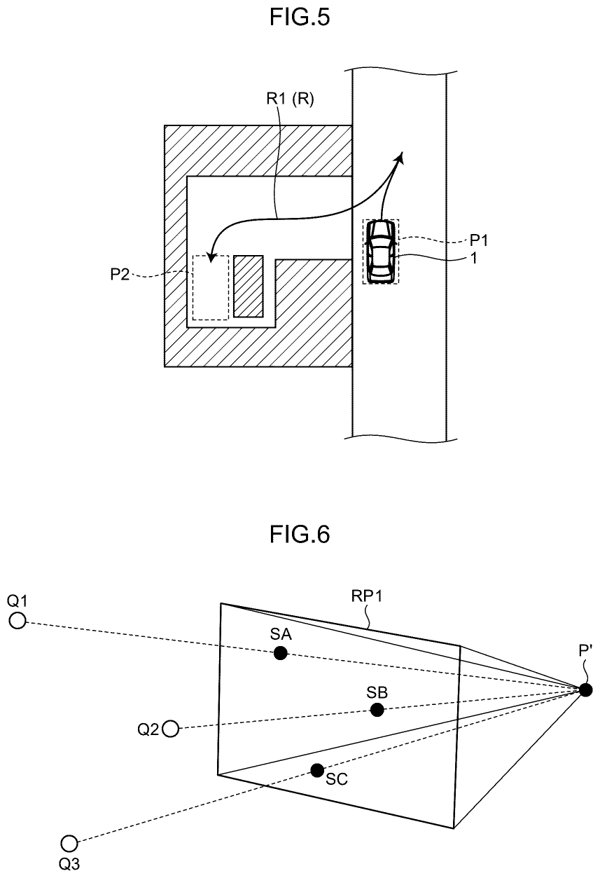

FIG. 5 is an explanatory diagram of an example of a teacher route R1.

In the teacher driving mode, the teacher driving from a predetermined position P1 to a parking target position P2 is performed by the manual operation by the occupant. The parking target position P2 is, for example, a parking lot or the like, but is not limited thereto. Further, the predetermined position P1 may be any position of the occupant in the real space.

The driving route R through which the teacher driving is performed is treated as the teacher route R1, and the teacher route data 18A of the teacher route R1 is stored in the storage device 18. During the teacher driving, the occupant may perform the manual operation to drive the vehicle from the parking target position P2 toward the predetermined position P1, or may perform the manual operation to drive the vehicle from the predetermined position P1 toward the parking target position P2. When the vehicle 1 is driven from the parking target position P2 toward the predetermined position P1 in the teacher driving mode, the controller 11 may create the teacher route data 18A of the teacher route R1 in which the driving direction of the driving route R during the teacher driving is set to the reverse direction. When the vehicle 1 is driven from the predetermined position P1 toward the parking target position P2 during the teacher driving, the controller 11 may create the teacher route data 18A of the teacher route R1 along the driving direction of the driving route R during the teacher driving. Details of the creation of the teacher route data 18A will be described later.

In the autonomous driving mode, the controller 11 controls at least steering along the driving route R obtained by the teacher driving to autonomously drive the vehicle 1 to the parking target position P2. In the autonomous driving mode, the controller 11 executes steering control of the vehicle 1 and front and rear acceleration/deceleration control, but at least a part of front and rear acceleration/deceleration control may be executed by the operation of the driver.

Next, control by the controller 11 in each of the teacher driving mode and the autonomous driving mode will be described in detail.

### In Teacher Driving Mode

First, the control of the controller 11 in the teacher driving mode will be described in detail.

The controller 11 switches the driving mode to the teacher driving mode when receiving a signal indicating an instruction to start the teacher driving mode by the operation or the like of the operation device 20 by the occupant. Then, the controller 11 executes the following processing in the teacher driving mode.

The controller 11 acquires sensor information indicating a driving state of the vehicle 1 from the sensor 14. Then, the controller 11 estimates the current position of the vehicle 1 based on a temporal change in the sensor value represented by the sensor information. For example, the controller 11 calculates a movement amount of the vehicle 1 from a reference position such as a driving start position when the teacher driving mode is started based on a temporal change in the vehicle speed and the yaw rate represented by the sensor values, and estimates the current position of the vehicle 1 based on the movement amount.

Note that the estimation accuracy of the current position based on the movement amount may be low. Therefore, the controller 11 may use, as the current position, a result of correcting the estimated current position based on the captured video around the vehicle 1 acquired by the camera 16.

The controller 11 sequentially stores the current position of the vehicle 1 sequentially estimated along the driving of the vehicle 1 in the storage device 18. Specifically, the controller 11 sets, as the teacher route R1, the driving route R during the teacher driving represented by a group of current positions sequentially estimated from a time point when the instruction to start the teacher driving mode is received until the instruction to end the teacher mode is received, and stores the teacher route data 18A representing the teacher route R1 in the storage device 18.

The teacher route data 18A includes a group of pieces of driving information for each position which is a current position sequentially estimated during the teacher driving. The driving information includes an INDEX, a driving position, an azimuth, a driving direction, and reference driving information. The INDEX is identification information of driving information. The driving position is the estimated position of the vehicle 1. The azimuth indicates the direction of the vehicle 1 at the position. The driving direction indicates a driving direction of the vehicle 1 at the position, and is represented by, for example, forward movement or backward movement. The reference driving information is information representing a driving state or the like at the position. The reference driving information is, for example, information such as a steering angle and a vehicle speed detected at each position during the teacher driving.

In addition, during the teacher driving of the vehicle 1, the controller 11 creates the map data 18B for estimating the current position of the vehicle 1 from the captured video captured by the camera 16. As a method for estimating the current position of the vehicle 1 from the captured video, a simultaneous localization and mapping (SLAM) method or the like is used.

The map data 18B is map data in which a plurality of feature points around the vehicle 1 at the time of driving along the teacher route R1 are registered.

The feature point is a feature point obtained by performing image analysis on the captured video captured by the camera 16 during the teacher driving. For example, the feature point is a part where a characteristic image pattern is obtained by analyzing the captured video in an object (for example, a tree, a wall, a column, or the like) or the like that can be a mark in the real view. The part is, for example, an edge part of the object. The map data 18B includes a plurality of feature points, and each feature point is identifiably registered for each feature point by being assigned an identification number.

The feature point is represented by feature point data including a three-dimensional position and a feature amount. The three-dimensional position of the feature point is a three-dimensional position of the feature point in the real space, and is represented by, for example, a three-dimensional orthogonal coordinate system (X, Y, Z). The feature amount of the feature point is a feature amount represented by image analysis of the captured video of the feature point. The feature amount of the feature point is, for example, luminance and density on the captured video, a scale invariant feature transform (SIFT) feature amount, a speeded up robust features (SURF) feature amount, or the like.

In the map data 18B, one feature point is registered for each identical three-dimensional position. Note that, for the same three-dimensional position, a plurality of feature points may be registered in the map data 18B for each photographing position and photographing direction by the camera 16 at the three-dimensional position. In addition, the feature point data of the feature points registered in the map data 18B may further include image data of an object having the feature point.

During the teacher driving, the controller 11 specifies coordinates of feature points in the real view based on, for example, stereo photogrammetry. Specifically, the controller 11 reads a plurality of captured videos captured at different timings, and associates the same feature point commonly appearing in the plurality of captured videos. Then, for example, the controller 11 estimates a temporary position of the vehicle 1 when the plurality of captured videos are captured, and specifies temporary coordinates of the feature point in the real view by the principle of triangulation. Then, for example, the controller 11 performs bundle adjustment using the temporary position of the vehicle 1 and the temporary coordinates of the feature point in the real view as reference information, and calculates the formal position of the vehicle 1 and the formal coordinates of the feature point in the real view to minimize a reprojection error when each feature point in the real view is projected on all the captured videos. Then, the controller 11 stores, in the storage device 18, the map data 18B in which the feature point represented by the feature point data including the formal coordinates of the feature point in the real view as the three-dimensional position is registered.

The three-dimensional position of the feature point registered in the map data 18B may be a position measured in advance using LiDAR or a stereo camera without using the SLAM method. However, from the viewpoint of suppressing a decrease in position estimation accuracy, the SLAM method may be used.

As described above, the controller 11 executes the above processing in the teacher driving mode. Therefore, during the teacher driving mode, the controller 11 generates the teacher route data 18A of the teacher route R1 obtained by the teacher driving from the predetermined position P1 to the parking target position P2 and the map data 18B in which the three-dimensional position of each of the plurality of feature points around the vehicle 1 during the driving along the teacher route R1 and the feature amount of the feature point are registered, and stores the generated data in the storage device 18.

### Autonomous Driving Mode

Next, the control of the controller 11 during the autonomous driving mode will be described in detail.

The controller 11 switches the driving mode to the autonomous driving mode when receiving a signal indicating an instruction to start the autonomous driving mode as the operation device 20 receives the first operation by the operation or the like of the operation device 20 by the occupant. Then, the controller 11 executes the following processing in the autonomous driving mode.

The controller 11 reads the teacher route data 18A and the map data 18B from the storage device 18, and controls the movement control device 12 to perform autonomous driving along the teacher route R1 represented by the teacher route data 18A.

The controller 11 estimates the current position of the vehicle 1 based on the map data 18B and the captured video around the vehicle 1 acquired by at least one camera 16.

FIG. 6 is an explanatory diagram of an example of estimation processing of the current position of the vehicle 1 executed by the controller 11 during the autonomous driving mode.

S1, S2, and S3 in FIG. 6 represent three feature points extracted from the captured video of the camera 16, and points Q1, Q2, and Q3 are feature points stored in the map data 18B, and represent three-dimensional positions of the feature points SA, SB, and SC in real space. RP1 represents an imaging plane of the camera 16. The point P′ represents the position (that is, the position of the vehicle 1) of the camera 16 obtained from the three feature points SA, SB, and SC extracted from the captured video of the camera 16 and the feature points (Q1, Q2, Q3) stored in the map data 18B.

For example, the controller 11 first collates the feature points extracted from the captured video of the camera 16 with the feature points stored in the map data 18B using pattern matching, feature amount search, or the like. Then, the controller 11 randomly selects several (for example, 3 to 6) feature points among the feature points extracted from the captured video of the camera 16 and the feature points that can be collated with the feature points stored in the map data 18B.

Then, the controller 11 estimates the current position of the vehicle 1 in the real space based on the positions of these several feature points in the captured video and the three-dimensional positions of the feature points registered in the map data 18B corresponding to the several feature points in the real space. At this time, the controller 11 estimates the current position of the vehicle 1 by solving the PnP problem using, for example, a known method (for example, the document: Mikael Persson et al. “Lambda Twist: An Accurate Fast Robust Perspective Three Point (P3P) Solver.”, ECCV 2018, pp 334-349, published in 2018, http://openaccess.thecvf.com/content_ECCV_2018/papers/Mikae l_Persson_Lambda_Twist_An_ECCV_2018_paper.pdf) such as Lambda Twist.

When collating the feature points extracted from the captured video of the camera 16 with the feature points stored in the map data 18B, for example, the controller 11 may calculate the current position of the vehicle 1 as a temporary position based on the movement amount of the vehicle 1 described above, and may narrow down the feature points to be collated with the feature points extracted from the captured video of the camera 16 among the feature points stored in the map data 18B with the temporary position as a reference.

Through these processing, the controller 11 estimates, as the current position information indicating the current position of the vehicle 1, current position information including information related to the two-dimensional position (X coordinate, Y coordinate) of the vehicle 1 in the real space and the posture that is the direction of the vehicle 1 based on the map data 18B and the captured video around the vehicle 1 acquired by at least one camera 16.

Then, the controller 11 autonomously drives the vehicle 1 from the predetermined position P1 toward the parking target position P2 along the teacher route R1 by controlling the movement control device 12 such that the estimated current position of the vehicle 1 is a position on the teacher route R1 represented by the teacher route data 18A. Then, the controller 11 stops the vehicle 1 at the parking target position P2.

When the vehicle 1 is driven autonomously along the teacher route R1, the controller 11 feedback-controls the movement control device 12 such that the vehicle 1 moves along the teacher route R1 based on the estimated current position of the vehicle 1 and each position on the teacher route R1 represented by the teacher route data 18A.

Hereinafter, autonomous driving from the predetermined position P1 along the teacher route R1 to the parking target position P2 by the vehicle 1 will be referred to as first autonomous driving.

Here, there is a case where an obstacle is detected on the teacher route R1 while the vehicle 1 is moving along the teacher route R1 from the predetermined position P1 to the parking target position P2 by the first autonomous driving.

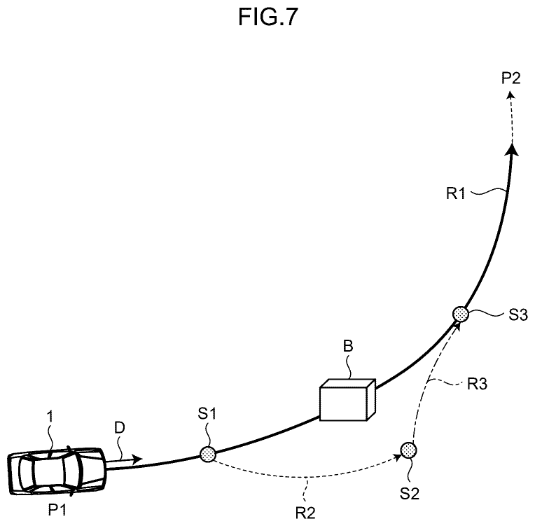

FIG. 7 is an explanatory diagram of an example of the case where an obstacle B is detected on the teacher route R1.

As illustrated in FIG. 7, there is a case where the obstacle B that is not present at the time of registration of the teacher route data 18A is present on the teacher route R1 during the first autonomous driving from the predetermined position P1 to the parking target position P2.

The obstacle B is an object that obstructs the driving of the vehicle 1. Specifically, the obstacle B is an object that causes difficulty in continuing driving when the vehicle 1 comes into contact with the object, or has a possibility of causing some damage to the vehicle 1 or an event that hinders driving when the vehicle 1 comes into contact with or tries to pass over the object without avoiding the object.

Therefore, in the present embodiment, the controller 11 determines whether or not the obstacle B has been detected in front of the vehicle 1 in a moving direction D based on the external situation acquired by the sensor 14 during the movement by the first autonomous driving.

Specifically, in the manual driving mode, the controller 11 drives the vehicle 1 in response to a steering operation on the steering device 27 by the occupant. Then, when the vehicle 1 is within a predetermined range from the predetermined position P1 and the operation device 20 receives the first operation, it switches to the autonomous driving mode. Thereafter, in the autonomous driving mode, at least steering is controlled along the teacher route R1 to perform first autonomous driving toward the parking target position P2.

The first operation may be a predetermined operation indicating an instruction to start the autonomous driving mode.

The predetermined range from the predetermined position P1 may be within a predetermined range from the predetermined position P1. The predetermined range from the predetermined position Pl may be a range narrower than the range from the predetermined position Pl to the parking target position P2.

In addition, the controller 11 determines whether or not the obstacle B has been detected in front of the vehicle 1 in the moving direction D based on the external situation acquired by the sensor 14 during the movement by the first autonomous driving.

For example, the controller 11 analyzes at least one of the sensor information received from the sensor 14 and the captured video captured by the camera 16 by known analysis processing to determine whether or not the obstacle B is present on the teacher route R1. Through this determination processing, the controller 11 determines whether or not the obstacle B has been detected ahead in the moving direction D.

More specifically, the controller 11 determines whether or not the obstacle B is present on the teacher route R1 in front of the vehicle 1 in the moving direction D by deriving the distance to the obstacle B and the position of the obstacle B by analyzing the detection result of the LiDAR, radar, ultrasonic sensor, or the like included in the sensor 14, image analysis of the obstacle B included in the captured video, and the like. Through this determination processing, the controller 11 determines whether or not the obstacle B has been detected in front of the vehicle 1 in the moving direction D.

In the present embodiment, when the controller 11 detects the obstacle B in front of the vehicle 1 in the moving direction D, the driving mode is switched to the temporary manual driving mode, and the operation device 20 and the steering device 27 receive the manual operation by the occupant.

For example, a scene is assumed in which the controller 11 detects the obstacle B in front of the vehicle 1 in the moving direction D based on the sensor information obtained by the sensor 14 when the vehicle 1 reaches the point S1 on the teacher route R1 during the movement of the vehicle 1 by the first autonomous driving along the teacher route R1 from the predetermined position P1 to the parking target position P2.

In this case, the controller 11 controls the movement control device 12 to stop the driving of the vehicle 1, and switches the driving mode from the autonomous driving mode to the temporary manual driving mode. When the controller 11 switches the driving mode from the autonomous driving mode to the temporary manual driving mode, the driving in response to the manual operation by the occupant is temporarily possible during the autonomous driving. That is, in the temporary manual driving mode, the operation device 20 and the steering device 27 receive the manual operation by the occupant, and accordingly, the vehicle 1 is driven in response to the manual operation by the occupant.

When detecting the obstacle B ahead in the moving direction D, the controller 11 causes the display device 22 to output the third screen. The third screen is a screen prompting the occupant to perform the manual operation for avoiding an obstacle. Specifically, for example, the third screen is a screen including at least one of a phrase prompting the occupant to perform the manual operation for avoiding the obstacle and a schematic diagram prompting the occupant to perform the manual operation for avoiding the obstacle.

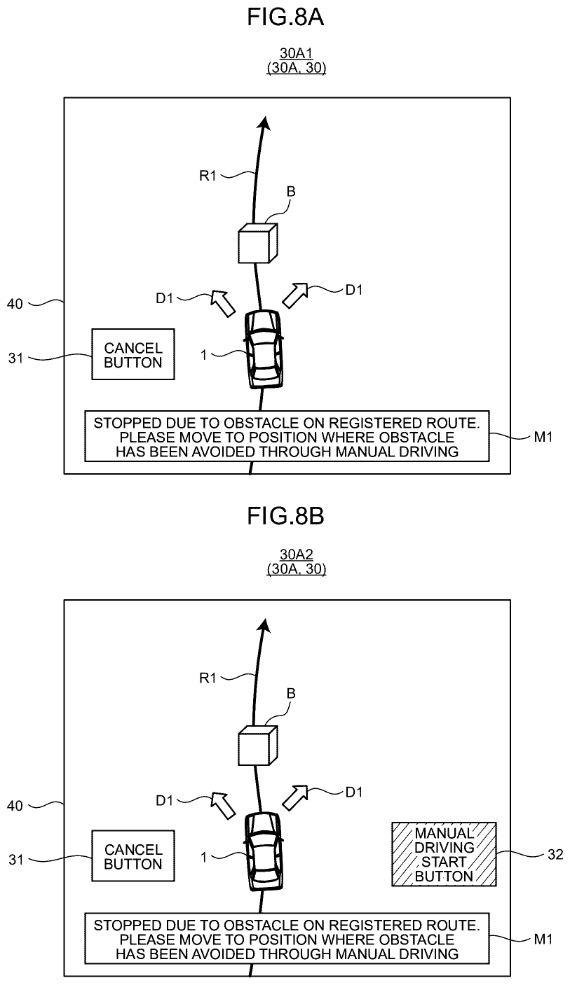

FIGS. 8A and 8B are schematic diagrams of an example of a third screen 30A. The third screen 30A is an example of a screen 30 output by the display device 22.

FIG. 8A is a schematic diagram of an example of a third screen 30A1. The third screen 30A1 is an example of the third screen 30A.

The third screen 30A1 is, for example, the screen 30 including a message M1, a schematic diagram D1, and a cancel button 31. FIG. 8A illustrates an example in which the message M1 includes an example of a phrase prompting the occupant to perform a manual operation for avoiding an obstacle: “Stopped due to an obstacle on the registered route. Please move to a position where the obstacle has been avoided through manual driving”. FIG. 8A illustrates, as an example, an aspect in which the schematic diagram D1 is an arrow image representing a recommended driving direction by the manual operation for avoiding an obstacle by the occupant. Note that the message M1 is not limited to the phrase illustrated in FIG. 8A as long as the message M1 includes a phrase prompting the occupant to perform a manual operation to avoid the obstacle. Similarly, the schematic diagram D1 may be any schematic diagram as long as the schematic diagram prompts the occupant to perform a manual operation for avoiding an obstacle, and is not limited to the aspect illustrated in FIG. 8A.

The cancel button 31 is an image area for receiving an instruction to switch from the autonomous driving mode or the temporary manual driving mode to the manual driving mode from the occupant. When the cancel button 31 is operated by the occupant to receive a switching instruction signal to the manual driving mode from the operation device 20 by the operation, the controller 11 switches the driving mode of the vehicle 1 to the manual driving mode. Then, the vehicle 1 controls the movement control device 12 to be driven in response to the manual operation of the occupant. The operation of the cancel button 31 by the occupant is an example of the second operation received by the operation device 20.

In addition, the third screen 30A1 may further include at least one of the captured video 40, at least one of a phrase and a schematic diagram representing the current position and posture of the vehicle 1, at least one of a phrase and a schematic diagram representing the teacher route R1, and at least one of a phrase and a schematic diagram representing the obstacle B. The captured video 40 included in the screen 30 may be either a captured video captured by the camera 16 in real time or a captured video captured in the past by the camera 16.

FIG. 8A illustrates, as an example, the third screen 30A1 in which an icon representing the vehicle 1 is arranged at a position corresponding to the current position of the vehicle 1 in the captured video 40 to have a posture corresponding to the current posture of the vehicle 1, and an arrow image representing the teacher route R1 and an icon representing the obstacle B are superimposed and displayed on the captured video 40.

In addition, when the obstacle B is detected ahead in the moving direction D, the controller 11 may further cause a speaker provided in the vehicle 1 to output a voice prompting the occupant to perform the manual operation for avoiding the obstacle.

FIG. 8B is a schematic diagram of an example of a third screen 30A2. The third screen 30A2 is an example of the third screen 30A.

The third screen 30A2 further includes an instruction button 32 for receiving an instruction to start manual driving from the occupant on the third screen 30A1 illustrated in FIG. 8A. As described above, the third screen 30A may further include the instruction button 32.

Returning to FIG. 7, the description will be continued.

According to the above processing, when the controller 11 detects the obstacle B ahead in the moving direction D during the movement by the first autonomous driving, the third screen 30A is displayed on the display device 22. Specifically, when the obstacle B is detected when the vehicle 1 reaches the point S1 on the teacher route R1, the vehicle 1 stops driving at the point S1, the autonomous driving mode is switched to the temporary manual driving mode, and the third screen 30A is output to the display device 22.

Then, when receiving the manual operation of the operation device 20 by the occupant, the controller 11 controls the movement control device 12 to be driven in response to the manual operation by the occupant. When the instruction button 32 illustrated in FIG. 8B is operated by the occupant and a manual operation start signal by the operation is received from the operation device 20, the controller 11 may control the movement control device 12 to be driven in response to the manual operation by the occupant.

When the manual operation by the occupant is started from the point S1 where the obstacle B has been detected, the steering device 27 (steering wheel, handle) or the like is operated by the occupant to avoid the obstacle B, and the vehicle 1 moves by the manual operation by the occupant (refer to a route R2 in FIG. 7).

While the manual operation is received, the controller 11 causes the display device 22 to output a fourth screen prompting the occupant to perform an operation indicating the avoidance completion when the avoidance of the obstacle B is completed. For example, the fourth screen includes at least one of characters and a schematic diagram prompting the occupant to perform an operation indicating avoidance completion when the avoidance of the obstacle B is completed.

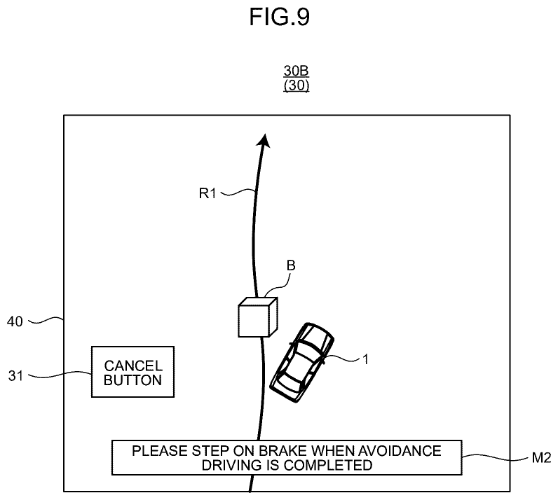

FIG. 9 is a schematic diagram of an example of a fourth screen 30B. The fourth screen 30B is an example of the screen 30 output by the display device 22.

The fourth screen 30B is, for example, the screen 30 including a message M2 and the cancel button 31. FIG. 9 illustrates an example in which the message M2 includes the phrase “Please step on the brake when the avoidance driving is completed” as an example. This phrase is an example of the phrase prompting the occupant to perform an operation indicating the avoidance completion when the avoidance of the obstacle B is completed. In this case, the operation indicating the avoidance completion is “stepping on the brake”.

The fourth screen 30B may be a screen in which at least the message M2 and the cancel button 31 are superimposed and displayed on the captured video 40. In addition, the fourth screen 30B may further include at least one of the captured video 40, at least one of a phrase and a schematic diagram representing the current position and posture of the vehicle 1, at least one of a phrase and a schematic diagram representing the teacher route R1, and at least one of a phrase and a schematic diagram representing the obstacle B.

FIG. 9 illustrates, as an example, the fourth screen 30B in which an icon representing the vehicle 1 is arranged at a position corresponding to the current position of the vehicle 1 in the captured video 40 to have a posture corresponding to the current posture of the vehicle 1, and an arrow image representing the teacher route R1 and an icon representing the obstacle B are superimposed and displayed on the captured video 40.

In addition, when the avoidance of the obstacle B has been completed, the controller 11 may further cause a speaker provided in the vehicle 1 to output a voice prompting the occupant to perform an operation indicating the avoidance completion.

Returning to FIG. 7, the description will be continued. In the temporary manual driving mode, the controller 11 causes the display device 22 to output the fourth screen 30B while the operation device 20 receives the manual operation by the occupant. Therefore, the display device 22 switches to the temporary manual driving mode at the point S1 where the obstacle B has been detected, and outputs the fourth screen 30B to the display device 22 while the manual operation by the occupant is started and the manual operation is received. That is, in the temporary manual driving mode, the display device 22 outputs the fourth screen 30B during the movement on the route R2 through which the vehicle 1 passes while the operation device 20 is operated by the occupant to avoid the obstacle B and the vehicle 1 moves by the manual operation of the occupant. The route R2 is an example of a movement trajectory of the vehicle 1 moved by the manual operation of the occupant.

When the obstacle B is detected in front of the vehicle 1 in the moving direction D, the display device 22 outputs the fourth screen 30B while receiving the manual operation by the occupant, and accordingly, it is possible to prompt the occupant to perform the operation indicating the avoidance completion when the avoidance of the obstacle B is completed by the manual operation.

Thereafter, in the temporary manual driving mode, the controller 11 causes the display device 22 to output the first screen when the obstacle B is not detected in front of the vehicle 1 in the moving direction D based on the external situation acquired by the sensor 14 after the vehicle 1 is moved by the manual operation by the occupant. The first screen is the screen 30 representing return to the teacher route R1 by autonomous driving.

Specifically, when the vehicle 1 starts moving by the manual operation by the occupant, the controller 11 determines whether or not the obstacle B has been detected in front of the vehicle 1 in the moving direction D based on the external situation acquired by the sensor 14. The controller 11 may determine whether or not the obstacle B is present in front or the vehicle 1 in the moving direction D in the same manner as described above using the sensor information received from the sensor 14. When determining that the obstacle B is not detected in front of the vehicle 1 in the moving direction D, the controller 11 causes the display device 22 to output the first screen.

For example, a scene is assumed in which the operation device 20 is operated by the occupant to avoid the obstacle B when the manual operation by the occupant is started from the point S1 where the obstacle B is detected, and the vehicle 1 is moved by the manual operation by the occupant (refer to the route R2 in FIG. 7). Then, a scene is assumed in which the controller 11 determines that the obstacle B is not detected in front of the vehicle 1 in the moving direction D when the vehicle 1 reaches the point S2. In this case, the controller 11 causes the display device 22 to output the first screen.

The controller 11 may cause the display device 22 to output the first screen when determining that the obstacle B is not detected in front of the vehicle 1 in the moving direction D and receiving a predetermined operation instruction such as stepping on the brake by the occupant.

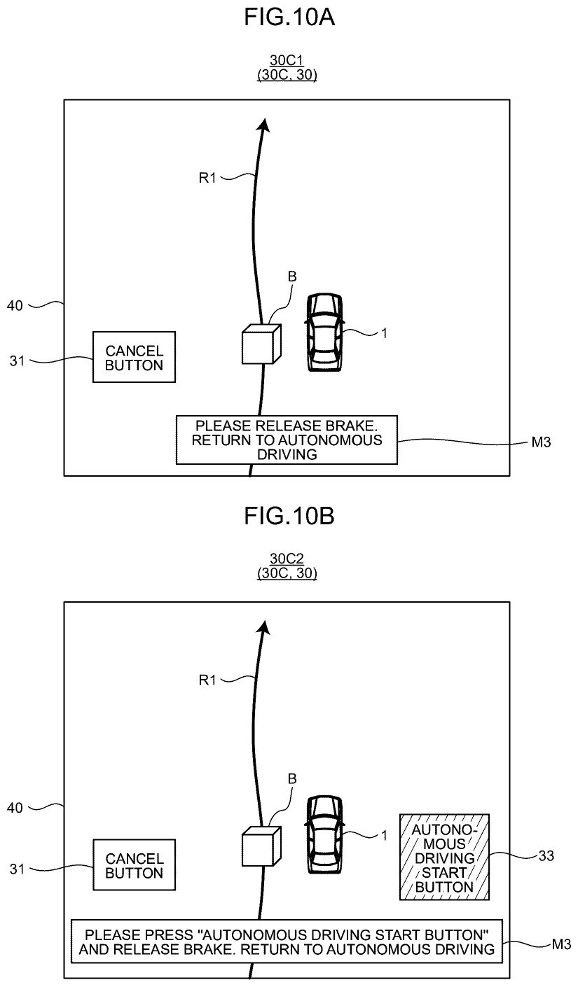

FIGS. 10A and 10B are schematic diagrams of an example of a first screen 30C. The first screen 30C is an example of the screen 30 output by the display device 22.

FIG. 10A is a schematic diagram of an example of a first screen 30C1. The first screen 30C1 is an example of the first screen 30C.

The first screen 30C1 is, for example, the screen 30 including a message M3 and the cancel button 31. FIG. 10A illustrates an example in which the message M3 includes the phrase “Please release the brake. Return to autonomous driving”. This phrase is an example of a phrase indicating return to the teacher route R1 by autonomous driving.

The first screen 30C1 may be the screen 30 that includes at least one of a phrase indicating return to the teacher route R1 by autonomous driving and a schematic diagram indicating return to the teacher route R1 by autonomous driving.

In addition, the first screen 30C1 may further include at least one of the captured video 40, at least one of a phrase and a schematic diagram representing the current position and posture of the vehicle 1, at least one of a phrase and a schematic diagram representing the teacher route R1, and at least one of a phrase and a schematic diagram representing the obstacle B.

FIG. 10A illustrates, as an example, the first screen 30C1 in which an icon representing the vehicle 1 is arranged at a position corresponding to the current position of the vehicle 1 in the captured video 40 to have a posture corresponding to the current posture of the vehicle 1, and an arrow image representing the teacher route R1 and an icon representing the obstacle B are superimposed and displayed on the captured video 40.

FIG. 10B is a schematic diagram of an example of a first screen 30C2. The first screen 30C2 is an example of the first screen 30C.

The first screen 30C2 further includes an instruction button 33 for receiving an instruction to start autonomous driving from the occupant on the first screen 30C1 illustrated in FIG. 10A. As described above, the first screen 30C may further include the instruction button 33.

In addition, when the obstacle B is not detected in front of the vehicle 1 in the moving direction D based on the external situation acquired by the sensor 14 after the vehicle 1 is moved by the manual operation, the controller 11 may further cause a speaker provided in the vehicle 1 to output a voice indicating return to the teacher route R1 by autonomous driving.

Returning to FIG. 7, the description will be continued.

By the above processing, switching to the temporary manual driving mode is performed at the point S1 where the obstacle B has been detected, the manual operation by the occupant is started, and accordingly, the vehicle 1 moves by the manual operation of the operation device 20 and the steering device 27 by the occupant (refer to the route R2 in FIG. 7), and for example, when it is determined that the obstacle B is not detected ahead in the moving direction D when the vehicle 1 reaches the point S2, the display device 22 outputs the first screen 30C. That is, in the case of the example illustrated in FIG. 7, for example, when the vehicle 1 which has moved by manual operation reaches the point S2, the display device 22 outputs the first screen 30C.

By the display device 22 outputting the first screen 30C, it is possible to provide the occupant in a recognizable manner that the vehicle 1 returns to the teacher route R1 by autonomous driving when the obstacle B is avoided by the manual operation by the occupant.

Then, the controller 11 controls the movement control device 12 to perform the second autonomous driving to the halfway point S3 between the predetermined position P1 and the parking target position P2 on the teacher route R1, and then perform the third autonomous driving from the halfway point S3 to the parking target position P2.

The halfway point S3 may be any point between the predetermined position P1 and the parking target position P2 on the teacher route R1. Specifically, the halfway point S3 may be any point between the avoided obstacle B and the parking target position P2 on the teacher route R1.

The second autonomous driving means autonomous driving from the point S2 where the obstacle B is avoided by the movement of the vehicle 1 by the manual operation by the occupant and the obstacle B is no longer detected ahead in the moving direction D to the halfway point S3. The third autonomous driving means autonomous driving from the halfway point S3 to the parking target position P2.

The controller 11 may control the movement control device 12 to perform the second autonomous driving based on the difference between the teacher route R1 and the position of the vehicle 1 at that time. That is, the controller 11 performs feedback control such that the vehicle 1 returns to the teacher route R1 based on the estimated current position of the vehicle 1 and each position on the teacher route R1 represented by the teacher route data 18A. Specifically, the controller 11 controls the movement control device 12 such that the difference between the estimated current position of the vehicle 1 and the position closest to the current position among the positions on the teacher route R1 represented by the teacher route data 18A gradually decreases. Furthermore, the controller 11 may perform adjustment to reduce the gain of the feedback control not to cause sudden steering. Furthermore, for example, the controller 11 may perform feedback control not to cause sudden steering by adjusting the correction amount of the difference or the correction amount of the angular deviation to be equal to or less than a predetermined value in a section of a predetermined distance from the start of driving from the point S2 toward the halfway point S3.

By such control, the controller 11 controls the movement control device 12 such that the vehicle 1 gradually approaches the teacher route R1 by drawing a trajectory such as the return route R3, for example, and reaches the halfway point S3 by reaching the teacher route R1.

Furthermore, the controller 11 may generate the return route R3 from the point S2 to the halfway point S3 before the start of the second autonomous driving to the halfway point S3, and control the movement control device 12 to perform the second autonomous driving based on the return route R3.

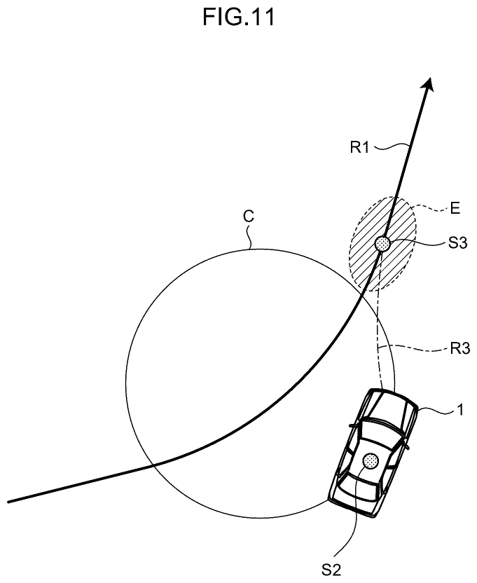

FIG. 11 is an explanatory diagram of an example of generation of the return route R3. For example, the controller 11 generates a virtual circle C having a radius obtained by adding a predetermined value to the minimum rotation radius of the vehicle 1, and arranges the circle center of the virtual circle C at a position closest to the current position of the vehicle 1 on the teacher route R1. Then, the controller 11 specifies, as the halfway point S3, a position on the teacher route R1 outside the virtual circle C on the teacher route R1 and in a section E where the route curvature and the change rate are stable. Then, the controller 11 generates, as the return route R3, a curve connecting the current position (for example, the point S2) of the vehicle 1 to the halfway point S3 within a predetermined curvature range.

Note that the controller 11 may specify the halfway point S3 by the above processing, calculate a route connecting the point S2 to the halfway point S3 by a known method, and generate the calculated route as the return route R3. In addition, the controller 11 may specify the halfway point S3 by a known method, calculate a route connecting the point S2 to the halfway point S3 by a known method, and generate the calculated route as the return route R3.

Then, when the return route R3 is generated, the controller 11 may control the movement control device 12 to perform the second autonomous driving along the return route R3 from the point S2 toward the halfway point S3.

Returning to FIG. 7, the description will be continued.

The controller 11 causes the display device 22 to output the second screen during at least a part of the time while the vehicle 1 is performing the second autonomous driving to the halfway point S3. The second screen is the screen 30 representing that the vehicle is in autonomous driving to return to the teacher route R1. For example, the second screen includes at least one of a phrase indicating that the vehicle is in autonomous driving to return to the teacher route R1 and a schematic diagram indicating that the vehicle is in autonomous driving to return to the teacher route R1.

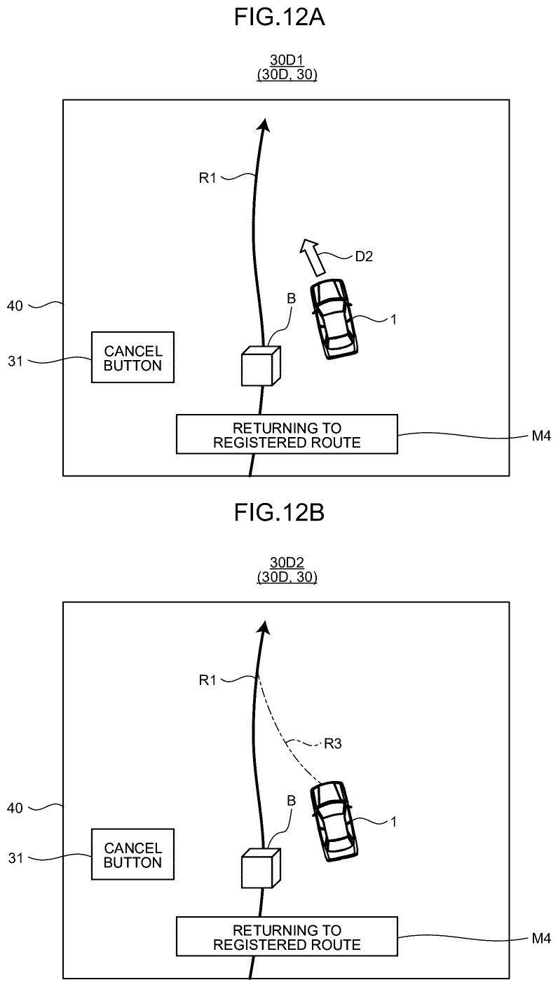

FIGS. 12A and 12B are schematic diagrams of an example of a second screen 30D. The second screen 30D is an example of the screen 30 output by the display device 22.

FIG. 12A is a schematic diagram of an example of a second screen 30D1. The second screen 30D1 is an example of the second screen 30D.

The second screen 30D1 is, for example, the screen 30 including a message M4, a schematic diagram D2, and the cancel button 31. FIG. 12A illustrates an example in which the message M4 includes the phrase “Returning to the registered route”. This phrase is an example of a phrase indicating that the vehicle is in autonomous driving to return to the teacher route R1. In addition, FIG. 12A illustrates an aspect in which the schematic diagram D2 is an arrow image representing that the vehicle is in autonomous driving to return to the teacher route R1 as an example. Note that the message M4 only needs to include the phrase indicating that the vehicle is in autonomous driving to return to the teacher route R1, and is not limited to the phrase illustrated in FIG. 12A. Similarly, the schematic diagram D2 may be any schematic diagram indicating that the vehicle is in autonomous driving to return to the teacher route R1, and is not limited to the aspect illustrated in FIG. 12A.

In addition, the second screen 30D1 may further include at least one of the captured video 40, at least one of a phrase and a schematic diagram representing the current position and posture of the vehicle 1, at least one of a phrase and a schematic diagram representing the teacher route R1, and at least one of a phrase and a schematic diagram representing the obstacle B. The schematic diagram representing the current position of the vehicle 1 is an example of a second image representing the position of the vehicle 1 at that time. The schematic diagram representing the teacher route R1 is an example of a first image representing the teacher route R1.

FIG. 12A illustrates, as an example, the second screen 30D1 in which an icon representing the vehicle 1 is arranged at a position corresponding to the current position of the vehicle 1 in the captured video 40 to have a posture corresponding to the current posture of the vehicle 1, and an arrow image representing the teacher route R1 and an icon representing the obstacle B are further superimposed and displayed on the captured video 40.

When the return route R3 is generated, the controller 11 may cause the display device 22 to output the second screen 30D further including the third image representing the generated return route R3.

FIG. 12B is a schematic diagram of an example of a second screen 30D2. The second screen 30D2 is an example of the second screen 30D.

As illustrated in FIG. 12B, when the return route R3 is generated, the controller 11 generates, for example, a line image representing the return route R3 as a third image, and causes the display device 22 to output the second screen 30D2 in which the third image is further superimposed on the second screen 30D1 illustrated in FIG. 12A. In this case, the display device 22 outputs the second screen 30D2 illustrated in FIG. 12B.

In addition, the controller 11 may further cause a speaker provided in the vehicle 1 to output a voice indicating that the vehicle 1 is in autonomous driving to return to the teacher route R1 during at least a part of the time while the vehicle 1 is performing second autonomous driving to the halfway point S3.

Returning to FIG. 7, the description will be continued.

The controller 11 controls the movement control device 12 such that the vehicle 1 performs the second autonomous driving from the point S2 to the halfway point S3, and then controls the movement control device 12 to perform the third autonomous driving from the halfway point S3 to the parking target position P2 along the teacher route R1.

During at least a part of the third autonomous driving, the controller 11 may cause the display device 22 to output a fifth screen. The fifth screen is the screen 30 representing that the vehicle returns to the teacher route R1 and continues autonomous driving. Specifically, the fifth screen is the screen 30 including at least one of a phrase and a schematic diagram indicating that the vehicle returns to the teacher route R1 and continues autonomous driving.

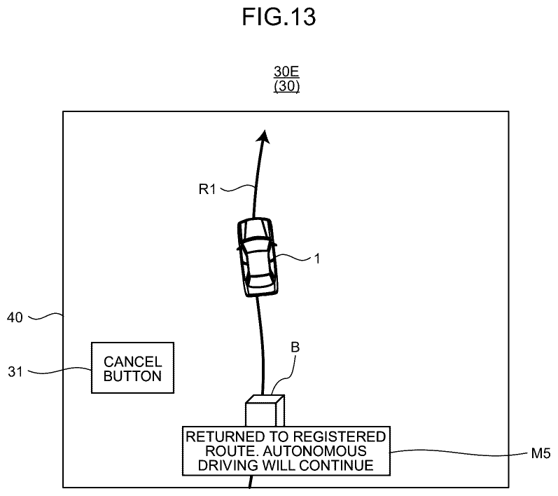

FIG. 13 is a schematic diagram of an example of a fifth screen 30E. The fifth screen 30E is an example of the screen 30.

The fifth screen 30E is, for example, the screen 30 including a message M5 and the cancel button 31. FIG. 13 illustrates an example in which the message M5 includes the phrase “Returned to the registered route. Autonomous driving will continue” as an example. The phrase is an example of a phrase indicating that the vehicle returns to the teacher route R1 and continues autonomous driving. In addition, the fifth screen 30E may further include a schematic diagram representing that the vehicle returns to the teacher route R1 and continues autonomous driving instead of or together with the phrase.

In addition, the fifth screen 30E may further include at least one of the captured video 40, at least one of a phrase and a schematic diagram representing the current position and posture of the vehicle 1, at least one of a phrase and a schematic diagram representing the teacher route R1, and at least one of a phrase and a schematic diagram representing the obstacle B.

When the vehicle 1 returns to the teacher route R1 after avoiding the obstacle B by the manual operation by the occupant, the display device 22 outputs the fifth screen 30E, and accordingly, information indicating that the vehicle 1 returns to the teacher route R1 and continues autonomous driving can be provided to the occupant.

Returning to FIG. 7, the description will be continued.

On the other hand, in the manual driving mode, when the vehicle 1 is driven in response to the steering operation on the steering device 27 by the occupant and the vehicle 1 is within a predetermined range from the predetermined position P1, the operation device 20 may not receive the first operation indicating the instruction to start the autonomous driving mode. In this case, ongoingly in the manual driving mode, the controller 11 drives the vehicle 1 to the parking target position P2 in response to the steering operation on the steering device 27 by the occupant.

As described above, the screen 30 (refer to the third screen 30A to the fifth screen 30E, and FIGS. 8A to 13) displayed in the temporary manual driving mode includes the cancel button 31. As described above, the cancel button 31 is an image area for receiving an instruction to switch to the manual driving mode from the occupant. In addition, the operation of the cancel button 31 by the occupant is an example of the second operation received by the operation device 20.

When the operation device 20 receives the second operation in the temporary manual driving mode, the controller 11 switches the driving mode to the manual driving mode. Then, in the manual driving mode, when the controller 11 does not detect the obstacle B in front of the vehicle 1 in the moving direction based on the external situation acquired by the sensor 14 after the vehicle 1 is moved by manual operation, the controller 11 does not display the first screen 30C. As described above, the first screen 30C is the screen 30 representing return to the teacher route R1 by autonomous driving. Therefore, the first screen 30C may be displayed in the temporary manual driving mode, but the first screen 30C is not displayed in the manual driving mode.

Next, an example of a flow of information processing executed by the controller 11 of the vehicle control device 10 will be described.

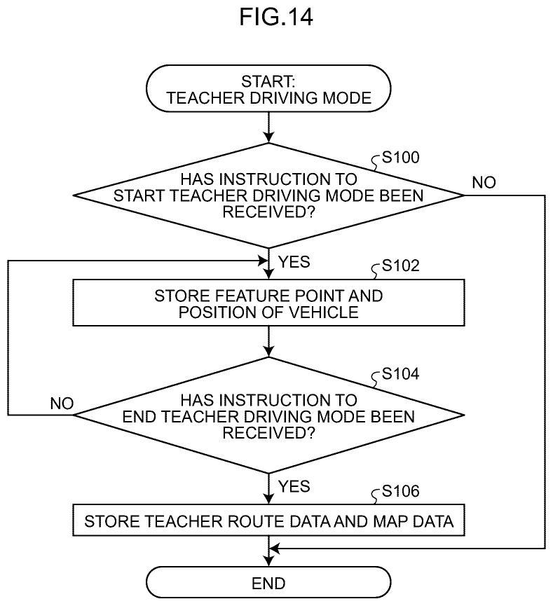

FIG. 14 is a flowchart illustrating an example of a flow of information processing executed by the controller 11 in the teacher driving mode.

The controller 11 determines whether or not a signal indicating the instruction to start the teacher driving mode has been received from the operation device 20 (step S100). When a negative determination is made in step S100 (step S100: No), this routine is ended. When an affirmative determination is made in step S100 (step S100: Yes), the process proceeds to step S102.

When the manual operation of the vehicle 1 by the occupant starts the teacher driving of the vehicle 1, the controller 11 sequentially stores the map data 18B and the current position of the vehicle 1 in the storage device 18 (step S102). Specifically, the controller 11 sequentially stores the current position of the vehicle 1 sequentially estimated along the teacher driving of the vehicle 1. At this time, the controller 11 assigns an INDEX to the current position, and sequentially stores the driving position, the azimuth, the driving direction, and the reference driving information, which are the current positions, in association with each other. In addition, the controller 11 specifies feature points by performing image analysis on the captured video captured by the camera 16 during the teacher driving, and sequentially registers the feature points in the map data 18B.

The controller 11 determines whether or not the instruction to end the teacher driving mode has been received (step S104). The controller 11 determines whether or not a signal indicating the end instruction has been received from the operation device 20 by the operation device 20 by the occupant, thereby making the determination in step S104. When a negative determination is made in step S104 (step S104: No), the controller 11 returns to step S102. When an affirmative determination is made in step S104 (step S104: Yes), the controller 11 returns to step S106.

In step S106, the controller 11 stores the teacher route data 18A and the map data 18B in the storage device 18 (step S106). The controller 11 sets the driving route R during the teacher driving represented by the group of sequentially estimated current positions stored in the processing of step S102 as the teacher route R1, and stores the teacher route data 18A representing the teacher route R1 in the storage device 18. In addition, the controller 11 stores the map data 18B in which the feature points specified by the processing in step S102 are registered in the storage device 18. Then, this routine is ended.

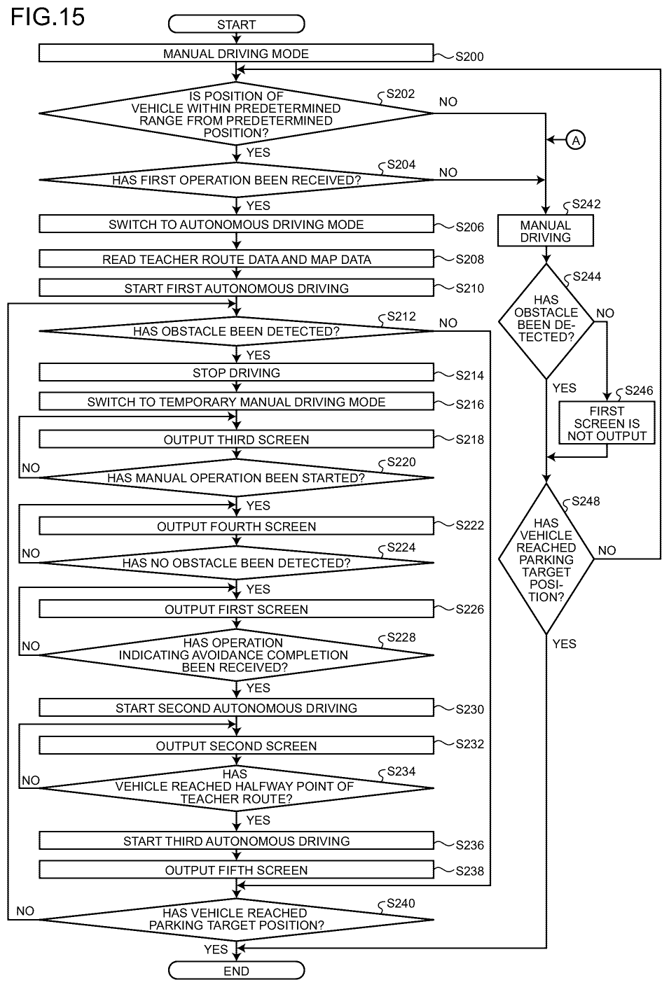

FIG. 15 is a flowchart illustrating an example of a flow of information processing executed by the controller 11 in the autonomous driving mode.

In the manual driving mode, the controller 11 drives the vehicle 1 in response to a steering operation on the steering device 27 by the occupant (step S200).

The controller 11 determines whether or not the position of the vehicle 1 is within a predetermined range from the predetermined position P1 (step S202). When an affirmative determination is made in step S202 (step S202: Yes), the process proceeds to step S204.

The controller 11 determines whether or not the operation device 20 has received the first operation (step S204). The controller 11 executes the determination of step S204 by determining whether or not a signal indicating the instruction to start the autonomous driving mode has been received from the operation device 20. When an affirmative determination is made in step S204 (step S204: Yes), the process proceeds to step S206.

In step S206, the controller 11 switches the driving mode from the manual driving mode to the autonomous driving mode (step S206). Then, the controller 11 reads the teacher route data 18A and the map data 18B from the storage device 18 (step S208). Then, the controller 11 controls the movement control device 12 to start the first autonomous driving from the predetermined position P1 toward the parking target position P2 along the teacher route R1 represented by the teacher route data 18A (step S210).

When the first autonomous driving is started, the controller 11 determines whether or not the obstacle B has been detected in front of the vehicle 1 in the moving direction D based on the external situation acquired by the sensor 14 (step S212). When a negative determination is made in step S212 (step S212: No), the process proceeds to step S240 to be described later. When an affirmative determination is made in step S212 (step S212: Yes), the process proceeds to step S214.

The controller 11 controls the movement control device 12 to stop driving of the vehicle 1 (step S214), and switches the autonomous driving mode to the temporary manual driving mode (step S216). When the controller 11 switches the autonomous driving mode to the temporary manual driving mode, driving in response to the manual operation by the occupant is enabled.

Next, the controller 11 causes the display device 22 to output the third screen 30A (step S218). By the processing in step S218, the display device 22 outputs the third screen 30A illustrated in FIG. 8A or 8B, for example.

The controller 11 determines whether or not the manual operation by the occupant is started (step S220). For example, the controller 11 determines whether or not the manual operation of the operation device 20 by the occupant is received, thereby making the determination in step S220. When a negative determination is made in step S220 (step S220: No), the controller 11 returns to step S218. When it is determined that the manual operation by the occupant is started (step S220: Yes), the process proceeds to step S222.

In step S222, the controller 11 causes the display device 22 to output the fourth screen 30B (step S222). By the processing in step S222, the display device 22 outputs, for example, the fourth screen 30B illustrated in FIG. 9 to the display device 22.

Then, the controller 11 determines whether or not the obstacle B has not been detected in front of the vehicle 1 in the moving direction D based on the external situation acquired by the sensor 14 (step S224). When determining that the obstacle B is detected (step S224: No), the controller 11 returns to step S222. When determining that the obstacle B has not been detected (step S224: Yes), the controller 11 proceeds to step S226.

In step S226, the controller 11 causes the display device 22 to output the first screen 30C (step S226). When an affirmative determination is made in step S224 (step S224: Yes) and a predetermined operation instruction such as stepping on the brake by the occupant is received, the controller 11 may cause the display device 22 to output the first screen 30C. By the processing in step S226, the display device 22 outputs the first screen 30C illustrated in FIG. 10A or 10B, for example.

Next, the controller 11 determines whether or not an operation indicating avoidance completion has been received from the occupant (step S228), and the controller 11 determines whether or not a predetermined operation such as releasing the leg from the brake by the occupant has been performed, thereby making the determination in step S228. When a negative determination is made in step S228 (step S282: No), the controller 11 returns to step S226. When an affirmative determination is made in step S228 (step S228: Yes), the controller 11 returns to step S230.

In step S230, the controller 11 controls the movement control device 12 to start the second autonomous driving to the halfway point S3 between the predetermined position P1 and the parking target position P2 on the teacher route R1 (step S230).

When the second autonomous driving is started, the controller 11 causes the display device 22 to output the second screen 30D (step S232). By the processing in step S232, the display device 22 outputs the second screen 30D illustrated in FIG. 12A or 12B, for example.

Then, the controller 11 determines whether or not the vehicle 1 has reached a point on the teacher route R1, that is, the halfway point S3 (step S234). For example, the controller 11 determines whether or not the current position of the vehicle 1 is on any position on the teacher route R1, thereby making the determination in step S234. When a negative determination is made in step S234 (step S234: No), the controller 11 returns to step S232. When an affirmative determination is made in step S234 (step S234: Yes), the controller 11 returns to step S236.

In step S236, the controller 11 controls the movement control device 12 to start the third autonomous driving along the teacher route R1 from the halfway point S3 to the parking target position P2 (step S236).

During at least a part of the third autonomous driving, the controller 11 causes the display device 22 to output the fifth screen 30E (step S238). By the processing in step S234, for example, the display device 22 outputs the fifth screen 30E illustrated in FIG. 13.

Then, the controller 11 determines whether or not the vehicle 1 has reached the parking target position P2 (step S240). When a negative determination is made in step S240 (step S240: No), the process proceeds to step S212. When an affirmative determination is made in step S240 (step S240: Yes), this routine is ended.

Meanwhile, when a negative determination is made in step S202 (step S202: No), the process proceeds to step S242. When a negative determination is made in step S204 (step S204: No), the process proceeds to step S242.

In step S242, manual driving for driving the vehicle 1 in response to the steering operation on the steering device 27 by the occupant is continued (step S242).

Next, the controller 11 determines whether or not the obstacle B has been detected in front of the vehicle 1 in the moving direction D based on the external situation acquired by the sensor 14 (step S244). When an affirmative determination is made in step S244 (step S244: Yes), the process proceeds to step S248. When the obstacle B is not detected (step S244: No), the controller 11 does not output the first screen 30C representing the return to the teacher route R1 by the autonomous driving to the display device 22 (step S246). Then, the process proceeds to step S248.

In step S248, the controller 11 determines whether or not the vehicle 1 has reached the parking target position P2 (step S248). When a negative determination is made in step S248 (step S248: No), the process proceeds to step S202. When an affirmative determination is made in step S248 (step S248: Yes), this routine is ended.

Next, an example of a flow of interrupt processing executed between the processing of steps S216 to S240 in the information processing illustrated in FIG. 15 by the controller 11 of the present embodiment will be described.

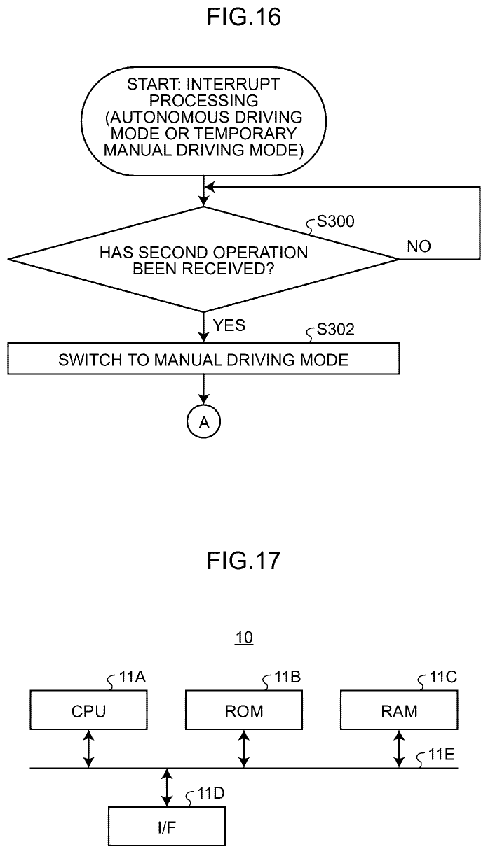

FIG. 16 illustrates an example of a flow of the interrupt processing executed by the controller 11 of the present embodiment. The controller 11 repeatedly executes the interrupt processing illustrated in FIG. 16 during the processing of steps S216 to S240 in the information processing illustrated in FIG. 15.

The controller 11 determines whether or not the operation device 20 has received the second operation (step S300). The controller 11 determines whether or not the cancel button 31 included in the screen 30 has been operated by the occupant, thereby making the determination in step S300. The controller 11 repeats the negative determination (step S300: No) until an affirmative determination is made in step S300 (step S300: Yes). When an affirmative determination is made in step S300 (step S300: Yes), the controller 11 switches the driving mode of the vehicle 1 to the manual driving mode (step S302). The process returns to step S242 in FIG. 15.

Therefore, when the operation device 20 receives the second operation in the temporary manual driving mode, the driving mode is switched to the manual driving mode.

The cancel button 31 may be included in the screen 30 displayed when the driving mode is the autonomous driving mode or the temporary manual driving mode. Therefore, in the autonomous driving mode or the temporary manual driving mode, when the occupant operates the cancel button 31 at any timing, the driving mode of the vehicle 1 can be switched from the autonomous driving mode or the temporary manual driving mode to the manual driving mode.

As described above, the vehicle control device 10 of the present embodiment controls the vehicle 1 including the sensor 14 that acquires the external situation, the operation device 20 that receives the operation by the occupant, the steering device 27 that receives the steering operation by the occupant, the display device 22 that can be visually recognized by the occupant, and the movement control device 12 that controls at least the steering, the vehicle 1 holding the teacher route R1 obtained by the teacher driving from the predetermined position P1 to the parking target position P2.

In the manual driving mode, the vehicle control device 10 drives the vehicle 1 in response to the steering operation on the steering device 27 by the occupant, and when the vehicle 1 is within the predetermined range from the predetermined position P1, and the operation device 20 receives the first operation, the vehicle control device 10 switches to the autonomous driving mode. Thereafter, in the autonomous driving mode, the vehicle control device 10 controls at least steering along the teacher route R1, and when the obstacle B is detected in front of the vehicle 1 in the moving direction D based on the external situation acquired by the sensor 14 while the vehicle 1 is moving from the predetermined position P1 toward the parking target position P2 by the first autonomous driving, the vehicle control device 10 switches to the temporary manual driving mode different from the manual driving mode, and the operation device 20 and the steering device 27 receive the manual operation by the occupant. Thereafter, in the temporary manual driving mode, after the vehicle 1 is moved by the manual operation, when the obstacle B is not detected in front of the vehicle 1 in the moving direction D based on the external situation acquired by the sensor 14, the display device 22 outputs the first screen 30C representing the return to the teacher route R1 by the autonomous driving. The vehicle control device 10 performs the second autonomous driving to the halfway point S3 between the predetermined position P1 and the parking target position P2 on the teacher route R1, and then performs the third autonomous driving along the teacher route R1 from the halfway point S3 to the parking target position P2.

In the manual driving mode, the vehicle control device 10 drives the vehicle 1 in response to the steering operation on the steering device 27 by the occupant. When the vehicle 1 is within the predetermined range from the predetermined position P1, and the operation device 20 does not receive the first operation, in the manual driving mode, the vehicle control device 10 continuously drives the vehicle 1 to the parking target position P2 in response to the steering operation on the steering device 27 by the occupant.

In the temporary manual driving mode, the vehicle control device 10 switches to the manual driving mode when the operation device 20 receives the second operation. In the manual driving mode, after the vehicle 1 is moved by the manual operation, when the obstacle B is not detected in front of the vehicle 1 in the moving direction D based on the external situation acquired by the sensor 14, the display device 22 does not output the first screen 30C representing the return to the teacher route 41 by the autonomous driving.

As described above, in the vehicle control device 10 of the present embodiment, in the autonomous driving mode, when the obstacle B is detected in front of the vehicle 1 in the moving direction D while the vehicle 1 is moving from the predetermined position P1 to the parking target position P2 by the first autonomous driving along the teacher route R1, switching to the temporary manual driving mode different from the manual driving mode is performed, and the operation device 20 receives the manual operation by the occupant. Then, in the vehicle control device 10, when the obstacle B is not detected in front of the vehicle 1 in the moving direction D after the vehicle 1 moves by the manual operation, the display device 22 outputs the first screen 30C representing the return to the teacher route R1 by the autonomous driving. In addition, the vehicle control device 10 performs the second autonomous driving to the halfway point S3 between the predetermined position P1 and the parking target position P2 on the teacher route R1, and then performs the third autonomous driving along the teacher route R1 from the halfway point S3 to the parking target position P2.

Therefore, in the autonomous driving mode, when the obstacle B that is not present during the teacher driving is present on the teacher route R1 during the autonomous driving along the teacher route R1, the vehicle control device 10 of the present embodiment can switch to the temporary manual driving mode different from the manual driving mode, prompt the occupant to perform the manual operation for avoiding the obstacle B by the manual operation, and autonomously drive the vehicle 1 from the point S2 where the obstacle B was avoided toward the parking target position P2 via the halfway point S3 on the teacher route R1.

Therefore, the vehicle control device 10 of the present embodiment can provide more suitable parking assistance.

In addition, according to the vehicle control device 10 of the present embodiment, in the temporary manual driving mode, the occupant performs the manual operation for avoiding the obstacle B, and accordingly, the vehicle 1 after avoiding the obstacle B is driven autonomously from the point (point S2) where the obstacle B was avoided toward the parking target position P2 via the halfway point S3. Therefore, the vehicle control device 10 of the present embodiment does not require the driving restart operation or the like by the occupant when the vehicle 1 returns to the teacher route R1. Therefore, in addition to the above effect, the vehicle control device 10 of the present embodiment can autonomously drive the vehicle 1 seamlessly from the point S2 where the obstacle B was avoided toward the parking target position P2.

Next, a hardware configuration of the vehicle control device 10 of the present embodiment will be described.

FIG. 17 is a block diagram illustrating a hardware configuration example of the vehicle control device 10.

The vehicle control device 10 has a hardware configuration using a normal computer in which a central processing unit (CPU) 11A, a read only memory (ROM) 11B, a random access memory (RAM) 11C, an I/F 11D for connecting to various devices, and the like are connected to each other by a bus 11E.

The CPU 11A is an arithmetic device that controls the entire processing of the vehicle control device 10. The RAM 11C stores data necessary for various processing by the CPU 11A. The ROM 11B stores programs and the like for realizing various processing by the CPU 11A. The I/F 11D is an interface that is connected to an external device or an external terminal via a communication line or the like and transmits and receives data to and from the connected external device or external terminal.

A program for executing the above-described various processing executed by the vehicle control device 10 is provided by being incorporated in the ROM 11B or the like in advance. The program for executing the vehicle control method executed in the present embodiment may be provided by being recorded in a computer-readable recording medium such as a CD-ROM, a flexible disk (FD), a CD-R, or a digital versatile disc (DVD) as a file in a format installable or executable in these devices.

In addition, the program for executing the vehicle control method executed in the present embodiment may be stored on a computer connected to a network such as the Internet and provided by being downloaded via the network. In addition, a program for executing the vehicle control method executed in the present embodiment may be provided or distributed via a network such as the Internet.

Although embodiments of the present disclosure have been described, the embodiments have been presented by way of example and are not intended to limit the scope of the invention. This embodiment can be implemented in various other aspects, and various omissions, substitutions, and changes can be made without departing from the gist of the invention. As well as being included in the scope and gist of the invention, this embodiment is included in the invention described in the claims and the equivalent scope thereof.

What is claimed is:

1. A vehicle control method executed by a vehicle that includes a sensor that acquires an external situation, an operation device that receives an operation by an occupant, a steering device that receives a steering operation by the occupant, a display device that is visually recognizable by the occupant, and a movement controller that controls at least steering, the vehicle holding a teacher route obtained by teacher driving from a predetermined position to a parking target position, wherein
in a manual driving mode, the vehicle is driven in response to a steering operation on the steering device by the occupant, and when the vehicle is within a predetermined range from the predetermined position, and the operation device receives a first operation, switching to an autonomous driving mode is performed,
thereafter, in the autonomous driving mode, when an obstacle is detected in front of the vehicle in a moving direction based on an external situation acquired by the sensor during movement from the predetermined position to the parking target position along the teacher route by first autonomous driving controlling at least the steering, switching to a temporary manual driving mode different from the manual driving mode is performed, and the operation device and the steering device receive a manual operation by the occupant,
thereafter, in the temporary manual driving mode, after the vehicle is moved by the manual operation, when the obstacle is not detected in front of the vehicle in the moving direction based on the external situation acquired by the sensor, the display device outputs a first screen representing return to the teacher route by autonomous driving,
after second autonomous driving is performed to a halfway point between the predetermined position and the parking target position on the teacher route, third autonomous driving is performed along the teacher route from the halfway point to the parking target position,
in the manual driving mode, the vehicle is driven in response to a steering operation on the steering device by the occupant, and when the vehicle is within a predetermined range from the predetermined position and the operation device does not receive a first operation, ongoingly in the manual driving mode, the vehicle is driven to the parking target position in response to a steering operation on the steering device by the occupant, and
in the temporary manual driving mode, when the operation device receives a second operation, switching to the manual driving mode is performed, and in the manual driving mode, after the vehicle is moved by the manual operation, when the obstacle is not detected in front of the vehicle in the moving direction based on an external situation acquired by the sensor, the display device does not output the first screen indicating return to the teacher route by autonomous driving.

2. The vehicle control method according to claim 1, wherein
the first screen includes at least one of a phrase indicating return to the teacher route by autonomous driving and a schematic diagram indicating return to the teacher route by autonomous driving.

3. The vehicle control method according to claim 1, wherein
the second autonomous driving is performed based on a difference between the teacher route and a position of the vehicle at that time.

4. The vehicle control method according to claim 1, wherein
the display device outputs a second screen representing that the vehicle is in autonomous driving to return to the teacher route during at least a part of the time while the vehicle is performing the second autonomous driving to the halfway point.

5. The vehicle control method according to claim 4, wherein
the second screen includes at least one of a phrase indicating that the vehicle is in autonomous driving to return to the teacher route and a schematic diagram indicating that the vehicle is in autonomous driving to return to the teacher route.

6. The vehicle control method according to claim 4, wherein
the second screen includes a first image representing the teacher route and a second image representing a position of the vehicle at that time.

7. The vehicle control method according to claim 6, wherein
in the temporary manual driving mode, after the vehicle is moved by the manual operation, when the obstacle is not detected in front of the vehicle in the moving direction based on an external situation acquired by the sensor, a return route is generated, and the second autonomous driving is performed based on the return route, and
the second screen further includes a third image representing the return route.

8. The vehicle control method according to claim 1, wherein
when an obstacle is detected in front of the vehicle in the moving direction based on an external situation acquired by the sensor, the display device displays a third screen prompting the occupant to perform a manual operation for avoiding the obstacle.

9. The vehicle control method according to claim 8, wherein
the third screen includes at least one of a phrase prompting the occupant to perform a manual operation for avoiding an obstacle, and a schematic diagram for prompting the occupant to perform a manual operation for avoiding an obstacle.

10. The vehicle control method according to claim 1, wherein
in the autonomous driving mode, when an obstacle is detected in front of the vehicle in the moving direction based on an external situation acquired by the sensor during movement from the predetermined position toward the parking target position along the teacher route by first autonomous driving controlling at least the steering, switching to a temporary manual driving mode different from the manual driving mode is performed, and while the operation device receives the manual operation by the occupant, the display device outputs a fourth screen prompting the occupant to perform an operation indicating avoidance completion when avoidance of the obstacle is completed.

11. A vehicle control device that controls a vehicle that includes a sensor that acquires an external situation, an operation device that receives an operation by an occupant, a steering device that receives a steering operation by the occupant, a display device that is visually recognizable by the occupant, and a movement controller that controls at least steering, the vehicle holding a teacher route obtained by teacher driving from a predetermined position to a parking target position, wherein
in a manual driving mode, the vehicle is driven in response to a steering operation on the steering device by the occupant, and when the vehicle is within a predetermined range from the predetermined position, and the operation device receives a first operation, switching to an autonomous driving mode is performed,
thereafter, in the autonomous driving mode, when an obstacle is detected in front of the vehicle in a moving direction based on an external situation acquired by the sensor during movement from the predetermined position to the parking target position along the teacher route by first autonomous driving controlling at least the steering, switching to a temporary manual driving mode different from the manual driving mode is performed, and the operation device and the steering device receive a manual operation by the occupant,
thereafter, in the temporary manual driving mode, after the vehicle is moved by the manual operation, when the obstacle is not detected in front of the vehicle in the moving direction based on the external situation acquired by the sensor, the display device outputs a first screen representing return to the teacher route by autonomous driving,
after second autonomous driving is performed to a halfway point between the predetermined position and the parking target position on the teacher route, third autonomous driving is performed along the teacher route from the halfway point to the parking target position,
in the manual driving mode, the vehicle is driven in response to a steering operation on the steering device by the occupant, and when the vehicle is within a predetermined range from the predetermined position and the operation device does not receive a first operation, ongoingly in the manual driving mode, the vehicle is driven to the parking target position in response to a steering operation on the steering device by the occupant, and
in the temporary manual driving mode, when the operation device receives a second operation, switching to the manual driving mode is performed, and in the manual driving mode, after the vehicle is moved by the manual operation, when the obstacle is not detected in front of the vehicle in the moving direction based on an external situation acquired by the sensor, the display device does not output the first screen indicating return to the teacher route by autonomous driving.

12. The vehicle control device according to claim 11, wherein
the first screen includes at least one of a phrase indicating return to the teacher route by autonomous driving and a schematic diagram indicating return to the teacher route by autonomous driving.

13. The vehicle control device according to claim 11, wherein
the second autonomous driving is performed based on a difference between the teacher route and a position of the vehicle at that time.

14. The vehicle control device according to claim 11, wherein
the display device outputs a second screen representing that the vehicle is in autonomous driving to return to the teacher route during at least a part of the time while the vehicle is performing the second autonomous driving to the halfway point.

15. The vehicle control device according to claim 14, wherein
the second screen includes at least one of a phrase indicating that the vehicle is in autonomous driving to return to the teacher route and a schematic diagram indicating that the vehicle is in autonomous driving to return to the teacher route.

16. The vehicle control device according to claim 14, wherein
the second screen includes a first image representing the teacher route and a second image representing a position of the vehicle at that time.

17. The vehicle control device according to claim 16, wherein
in the temporary manual driving mode, after the vehicle is moved by the manual operation, when the obstacle is not detected in front of the vehicle in the moving direction based on an external situation acquired by the sensor, a return route is generated, and the second autonomous driving is performed based on the return route, and
the second screen further includes a third image representing the return route.

18. The vehicle control device according to claim 11, wherein
when an obstacle is detected in front of the vehicle in the moving direction based on an external situation acquired by the sensor, the display device displays a third screen prompting the occupant to perform a manual operation for avoiding the obstacle.

19. The vehicle control device according to claim 18, wherein
the third screen includes at least one of a phrase prompting the occupant to perform a manual operation for avoiding an obstacle, and a schematic diagram for prompting the occupant to perform a manual operation for avoiding an obstacle.

20. The vehicle control device according to claim 11, wherein
in the autonomous driving mode, when an obstacle is detected in front of the vehicle in the moving direction based on an external situation acquired by the sensor during movement from the predetermined position toward the parking target position along the teacher route by first autonomous driving controlling at least the steering, switching to a temporary manual driving mode different from the manual driving mode is performed, and while the operation device receives the manual operation by the occupant, the display device outputs a fourth screen prompting the occupant to perform an operation indicating avoidance completion when avoidance of the obstacle is completed.
